(19) United States
(12) Patent Application Publication
(10) Pub. No.: US 2009/0283630 A1
(43) Pub. Date: Nov. 19, 2009

(54) Lighter-than-air vehicle for shading

(76) Inventors: Ahmed Z. Al-Garni, Kfupm (SA); Ayman H. Kassem, Kfupm (SA)

Correspondence Address: LITMAN LAW OFFICES, LTD., POST OFFICE BOX 15035, CRYSTAL CITY STATION, ARLINGTON, VA, 22215-0035, US

(21) Appl. No.: 12/153,259

(22) Filed: May 15, 2008

(51) Int. Cl. B64B 1/24; B64B 1/02; B64D 1/18

(52) U.S. Cl. 244/30; 244/136; 244/33; 244/58

(57) ABSTRACT

The lighter-than-air vehicle for shading is an airborne, movable system that provides sun shade for an open area. The vehicle is a substantially flat flying device having upper and lower surfaces, and which is filled with a lighter-than-air gas or gases, such as helium or hydrogen. The vehicle may be tethered to the ground through control wires, or may be fully autonomous and controlled by propeller fans. The required power may be provided by wire from ground, or through a portable power source, such as solar cells, mounted atop of vehicle. The vehicle has sun sensors that allow it to track the sun, and provides around the clock shaded area underneath its surface. The vehicle can also have pressure sensors and altitude sensors that may trigger an alarm in case of an emergency descent to the ground.

### BACKGROUND OF THE INVENTION

1. Field of the Invention

The present invention relates to lighter-than-air aircraft, balloons, or similar structures, and particularly to a lighter-than-air vehicle for shading that is useful in shading open areas in hot climate regions, and has special use for shading a moving crowd.

2. Description of the Related Art

Countries near the equator have hot climates, and may also have large desert regions. Although many forms of clothing have been adapted for wear in such regions, it is often desirable to have shade from the sun. Further, in some cases, a permanent structure is not necessary, but temporary shade will do. Canopies and tents can be used for this purpose, but canopies and tents require labor in the hot sun to set up and break down. Moreover, canopies and tents are stationary, and sometimes are too small to provide coverage for a large crowd.

There is a need for a mobile source of shade for hot or desert areas that can be used to provide temporary shade or relief from the hot sun for small groups of people or for crowds. Thus, a lighter-than-air vehicle for shading solving the aforementioned problems is desired.

### SUMMARY OF THE INVENTION

The lighter-than-air vehicle for shading is an airborne, movable system that provides sunshade for an open area. The vehicle is a substantially flat flying device having upper and lower surfaces, and which is filled with a lighter-than-air gas or gases, such as helium or hydrogen. The vehicle may be tethered to the ground through control wires, or may be fully autonomous and controlled by propeller fans. The required power may be provided by wire from ground, or through a portable power source, such as solar cells, mounted atop of vehicle. The vehicle has sun sensors that allow it to track the sun, and provides around the clock shaded area underneath its surface. The vehicle can also have pressure sensors and altitude sensors that may trigger an alarm in case of an emergency descent to the ground.

These and other features of the present invention will become readily apparent upon further review of the following specification and drawings.

### BRIEF DESCRIPTION OF THE DRAWINGS

FIG. 1 is a diagrammatic view showing shading provided by a lighter-than-air vehicle for shading according to the present invention.

FIG. 2A shows a front view in section of the lighter-than-air vehicle for shading according to the present invention.

FIG. 2B shows a side view of the lighter-than-air vehicle for shading according to the present invention.

FIG. 2C shows a top view of the lighter-than-air vehicle for shading according to the present invention.

FIG. 3 is a top view of the lighter-than-air vehicle for shading according to the present invention, showing an exemplary, optional solar cell configuration.

FIG. 4A is a side view of the lighter-than-air vehicle for shading according to the present invention, showing optional thrust motors disposed below the vehicle for navigation of the vehicle.

FIG. 4B is a side view of the lighter-than-air vehicle for shading according to the present invention, showing optional thrust motors disposed above the vehicle for navigation of the vehicle.

FIG. 4C is a side view of the lighter-than-air vehicle for shading according to the present invention, showing an optional centrally disposed thrust motor disposed above the vehicle for navigation of the vehicle.

FIG. 4D is a side view of the lighter-than-air vehicle for shading according to the present invention, showing an optional centrally disposed thrust motor disposed below the vehicle for navigation of the vehicle.

FIG. 5 is a diagrammatic view of a lighter-than-air vehicle for shading according to the present invention, shown tethered to the ground.

FIG. 6A is a diagrammatic view of the lighter-than-air vehicle for shading according to the present invention, shown being towed by a helicopter.

FIG. 6B is a diagrammatic view of the lighter-than-air vehicle for shading according to the present invention, shown being towed by a truck or other ground vehicle.

FIG. 7 is a diagrammatic view of the lighter-than-air vehicle for shading according to the present invention, showing a pattern of atomizers spraying a mist of water towards the ground.

FIG. 8 is a diagrammatic view of the lighter-than-air vehicle for shading according to the present invention, showing shade provided by the vehicle following a crowd after movement of the crowd.

Similar reference characters denote corresponding features consistently throughout the attached drawings.

### DETAILED DESCRIPTION OF THE PREFERRED EMBODIMENTS

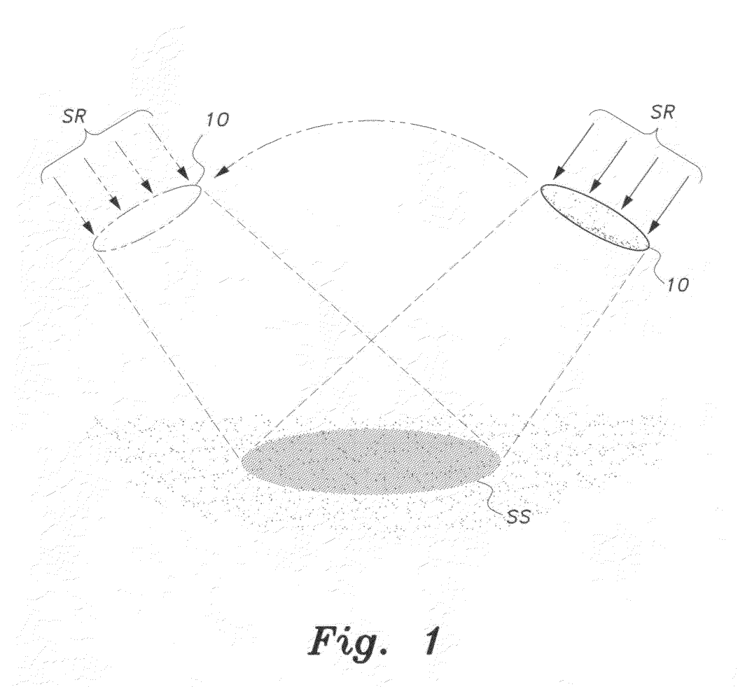

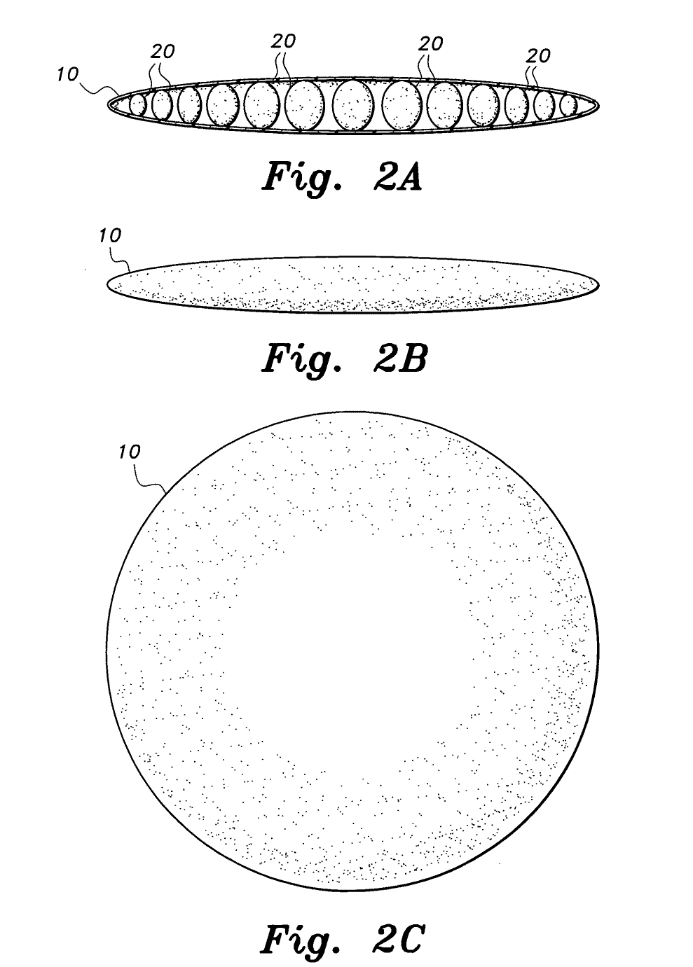

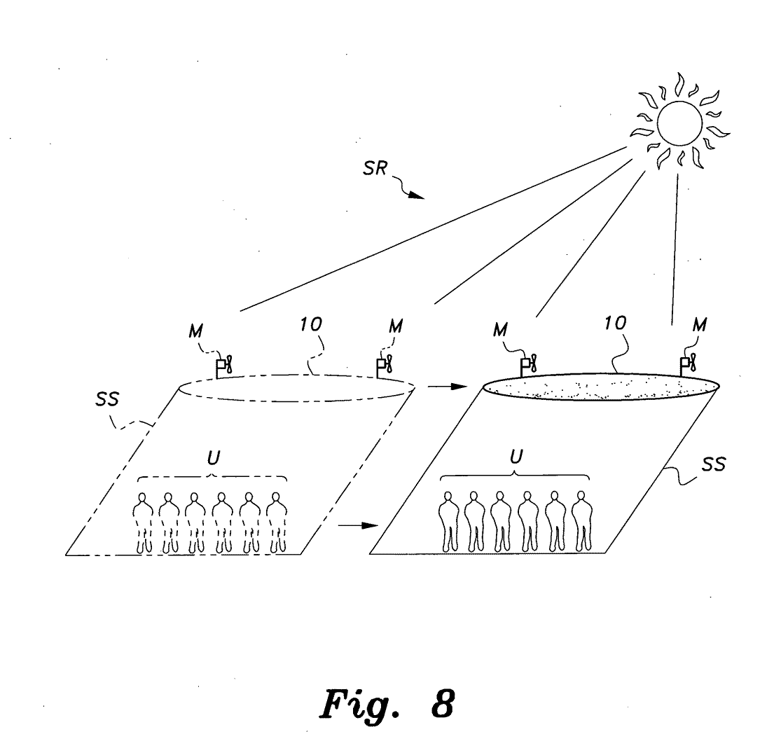

As shown in FIGS. 1 and 8, the present invention relates to a lighter-than-air vehicle for shading that provides an airborne, movable system for shade from the sun in an open area. As shown in FIGS. 1-2C, the lighter-than-air vehicle 10 is ellipsoidal or discoidal, having substantially flat upper and lower surfaces that enclose either a manifold or single chamber filled with a lighter-than-air gas or gases, or a hollow interior housing a plurality of gas bags or chambers 20 containing a lighter-than-air gas or gases, such as hydrogen, helium, argon, or the like. When the gas bags 20 are unfilled, the material of vehicle 10 is sufficiently flexible that it can be collapsed and folded over for compact storage and/or transport in, e.g., a light duty truck. The ellipsoidal or discoidal shape is aerodynamically efficient, being streamlined for reducing wind drag.

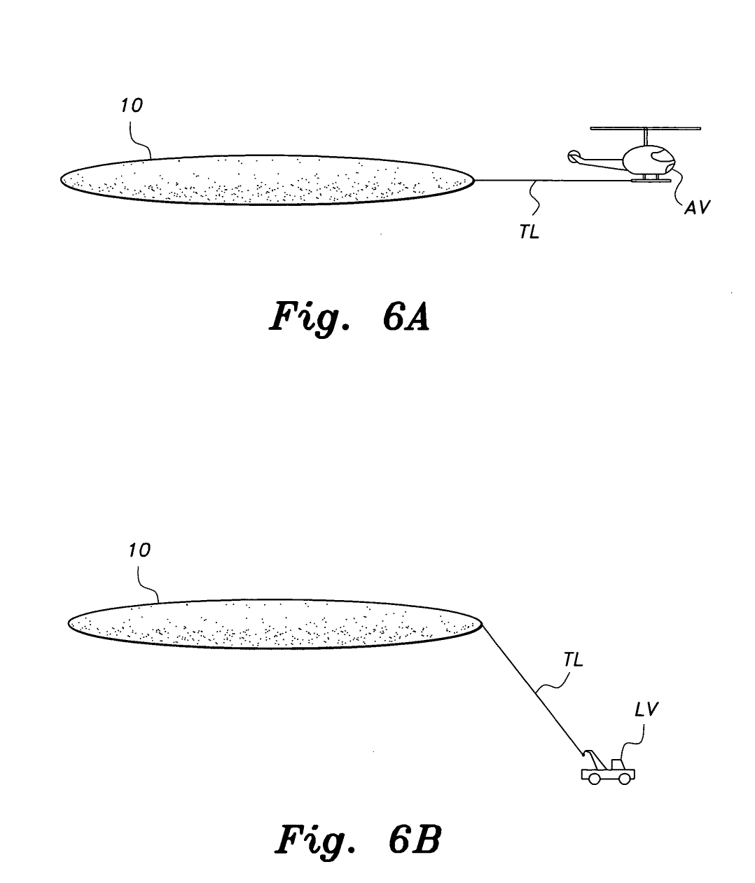

Moreover, when the gas bags 20 are filled and the vehicle 10 is deployed in the configuration shown in FIGS. 6A and 6B, a tow line TL may be attached to the vehicle 10 so that the balloon 10 can be towed by an aircraft, such as helicopter AV, or a land vehicle, such as tow truck LV. Exemplary material of vehicle 10 can be a simple net covered with continuous sheets of plastics to give shape while maintaining a low weight. The cover material may have rigid portions that can be used for attachment of motors and propellers to vehicle 10. The upper cover sheet may be painted in a bright reflecting color to reflect the sun rays and reduce heat. The lower cover may have electrically lighted signs to guide a crowd sheltering under the vehicle 10, or to give the crowd instructions. The lower surface can also be used for advertising. As most clearly shown in FIGS. 1 and 8, the discoidal shape of vehicle 10 can block impinging sun rays SR to create a shade surface SS on the ground to protect a crowd of people, such as crowd U.

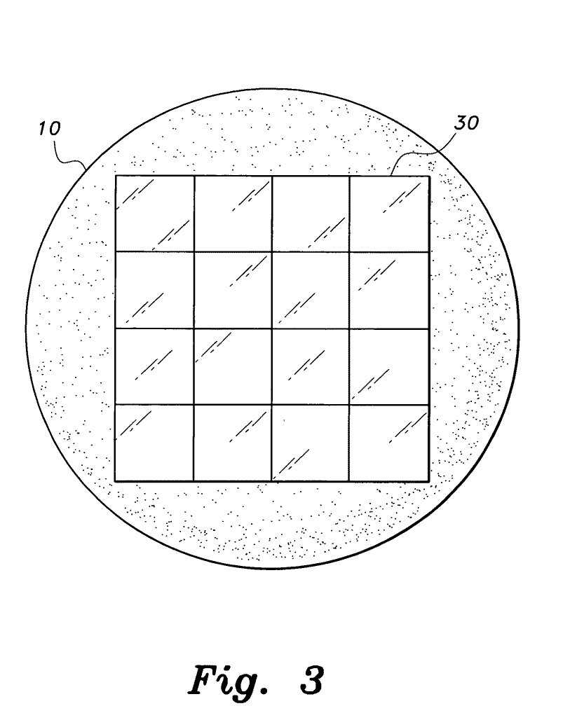

Under external control, or autonomously, the vehicle 10 tracks movement of the sun through the sky to maintain the shade surface SS on the ground. As shown in FIG. 3, control mechanisms employed by vehicle 10 may be powered by solar cells 30, which are preferably disposed on a top surface of vehicle 10. Alternatively, batteries may power the vehicle 10, or the solar cells 30 may be used in conjunction with rechargeable batteries. Small fans can be put on the surface of vehicle 10, where the air velocity is maximum, the fans being used as windmills to generate power for recharging the batteries.

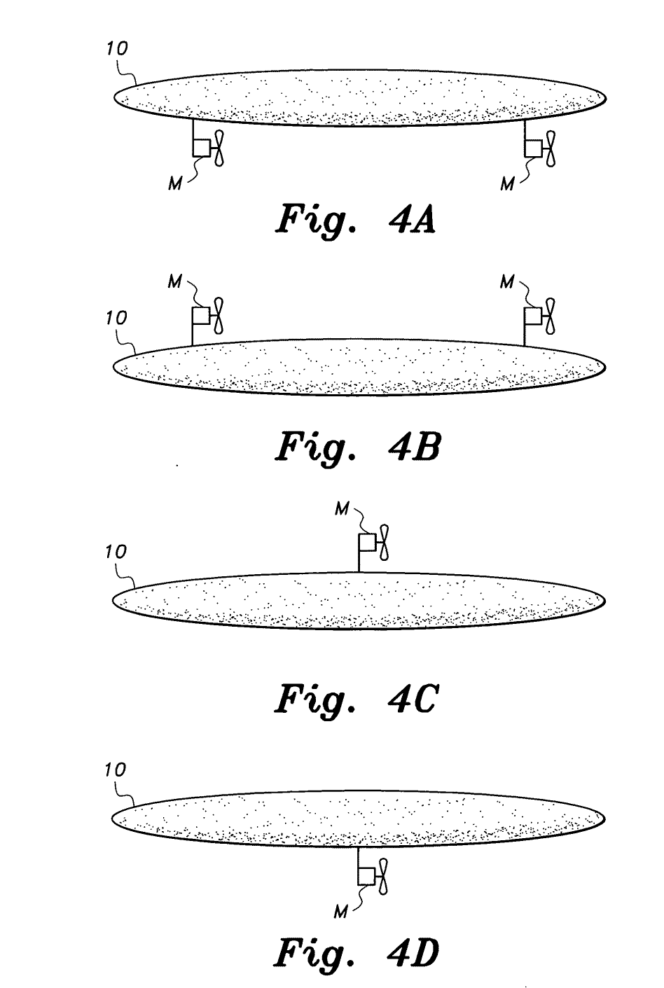

As shown in FIGS. 4A-4D, various combinations utilizing propeller motors M may be disposed on lighter-than-air vehicle 10 for use in navigating the vehicle 10. FIG. 4A shows the propeller systems M being disposed on the lower surface of vehicle 10, proximate the periphery of the lower surface. FIG. 4B shows the propeller motors M being disposed on the upper surface of vehicle 10 proximate the periphery of the upper surface. FIG. 4C shows a single propeller motor M disposed on the upper surface of vehicle 10 proximate a central vertical axis of the vehicle 10. FIG. 4D shows a single propeller motor M disposed on the lower surface of vehicle 10 proximate a central vertical axis of the vehicle 10. Upper surface configurations of propeller motors M are preferred for safety in case of crashing of the vehicle and falling on people below the vehicle 10. Preferably the propeller motors M are electrically driven.

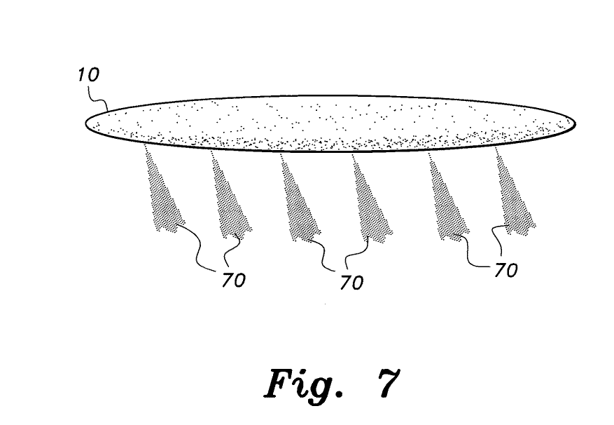

As shown in FIG. 7, cold water atomizers 70 may be disposed on the lower surface of the vehicle 10. The cold water atomizers 70 spray cold water downward into a shaded area, and can reduce ambient air temperature in the area shaded by vehicle 10.

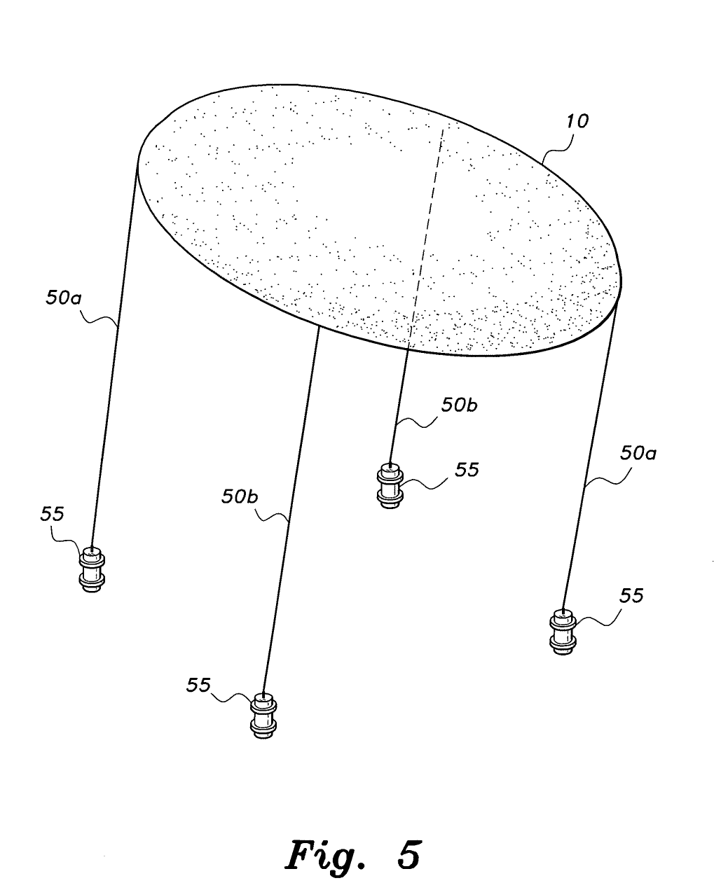

As shown in FIGS. 5 and 8, the vehicle 10 may be connected to the ground through control wires 50a and 50b, or the vehicle 10 may be fully autonomous and controlled by the propeller motors M. The altitude of balloon 10 can be controlled by ground control lines, which may be used to control mechanical or electrical navigational devices, or by a pump that controls the gas pressure inside the vehicle 10. FIG. 5 shows an exemplary control line configuration comprising control lines 50a extending from a first axis of the vehicle 10 and control lines 50b extending from a second axis of the vehicle 10, the second axis preferably being orthogonal to the first axis. Control motors 55 on the ground are configured to pay out or reel in control lines 50a and 50b as required. Control lines 50a and 50b can be used for initial anchoring, inclination angle, direction, movement and landing of vehicle 10.

The vehicle 10 may have sun sensors, which allow the vehicle 10 to track the sun in order to provide a shade area underneath the vehicle surface for the duration of sunlight. The vehicle 10 also may have pressure sensors and altitude sensors that can trigger an alarm in case of an emergency descent to the ground.

The vehicle 10 is preferably an unmanned vehicle, balloon, or drone controlled either mechanically by tether lines or electrically by remote control used to alternately apply thrust to the propeller motors, to operate other navigational control devices, or to control valves regulating pressure in the gas chamber(s).

It is to be understood that the present invention is not limited to the embodiments described above, but encompasses any and all embodiments within the scope of the following claims.

We claim:

1. A lighter-than-air vehicle for shading, comprising:
a discoidal body having substantially flat upper and lower surfaces;
at least one chamber disposed within the discoidal body; and
lighter-than-air gas disposed within the at least one chamber, the lighter-than-air gas providing the discoidal body with sufficient buoyancy to elevate the discoidal body aboveground in order to provide shade from direct sunlight.

2. The lighter-than-air vehicle according to claim 1, further comprising at least one control lines attached to the vehicle, the control line tethering said discoidal body to the ground.

3. The lighter-than-air vehicle according to claim 1, further comprising at least one propeller motor disposed on said discoidal body, the propeller motor providing thrust for vehicle navigation.

4. The lighter-than-air vehicle according to claim 1, further comprising a plurality of solar cells electrically connected to said propeller motors for furnishing power to said motors.

5. The lighter-than-air vehicle according to claim 1, wherein the discoidal body is collapsible for compact storage.

6. The lighter-than-air vehicle according to claim 1, further comprising a tow line attached to said discoidal body, whereby the vehicle may be towed to a designated shade.

7. The lighter-than-air vehicle according to claim 1, wherein said discoidal body is a streamlined in order to reduce wind drag.

8. The lighter-than-air vehicle according to claim 1, further comprising a plurality of atomizers disposed on the lower surface of said discoidal body for dispensing a cold water mist towards ground.

9. A method of providing shade from the sun in a desert area, comprising the step of casting an area of shade onto the desert area from a discoidal body containing lighter-than-air gas rendering the discoidal body airborne.

10. The method of providing shade according to claim 9, further comprising the step of selectively activating thrust motors attached to the discoidal body to move the area of shade cast by the discoidal body from one location to another location.

11. The method of providing shade according to claim 9, further comprising the step of towing the discoidal body to move the area of shade cast by the discoidal body from one location to another location.
